(19) United States
(12) Patent Application Publication
(10) Pub. No.: US 2023/0070430 A1
(43) Pub. Date: Mar. 9, 2023

(54) REFRIGERANT CIRCUIT SYSTEM AND CONTROL METHOD THEREFOR

(71) Applicant: TOYOTA JIDOSHA KABUSHIKI KAISHA, Toyota-shi (JP)

(72) Inventors: Ryo MICHIKAWAUCHI, Numazu-shi (JP); Hidefumi AIKAWA, Sunto-gun (JP); Tatsuhito MATSUMOTO, Nukata-gun (JP)

(73) Assignee: TOYOTA JIDOSHA KABUSHIKI KAISHA, Toyota-shi (JP)

(21) Appl. No.: 17/847,519

(22) Filed: Jun. 23, 2022

(30) Foreign Application Priority Data
Sep. 3, 2021 (JP) 2021-143947

(51) Int. Cl. B60H 1/00

(52) U.S. Cl. CPC B60H 1/00278; B60H 1/00878; B60H 2001/00307; B60H 2001/00949; B60H 2001/3267

(57) ABSTRACT

A refrigerant circuit system includes a compressor configured to compress refrigerant, a condenser configured to cause the compressed refrigerant to radiate heat, first and second evaporators each configured to decompress and expand the heat-radiated refrigerant by regulating a valve opening degree, first and second evaporators provided in parallel and configured to cause the refrigerant, respectively decompressed and expanded by the first and second expansion valves, to absorb heat, and a controller configured to, based on first information related to a temperature of a first temperature regulated object, regulated by the first evaporator, second information related to a temperature of a second temperature regulated object, regulated by the second evaporator, and third information related to a degree of superheat of the refrigerant at an inlet of the compressor, control the valve opening degrees of the first and second expansion valves and a compression ratio of the refrigerant by the compressor.

### CROSS-REFERENCE TO RELATED APPLICATION

This application claims priority to Japanese Patent Application No. 2021-143947 filed on Sep. 3, 2021, incorporated herein by reference in its entirety.

### BACKGROUND

### 1. Technical Field

The disclosure relates to a refrigerant circuit system and a control method therefor.

### 2. Description of Related Art

In recent years, battery electric vehicles (BEVs), hybrid electric vehicles (HEVs), and plug-in hybrid electric vehicles (PHEVs) equipped with batteries, fuel cell electric vehicles (FCEVs) that use hydrogen, and the like are in actual use. For example, a refrigerant circuit system provided with a first refrigerant circuit (chiller) that cools a battery and a second refrigerant circuit (evaporator) that cools the vehicle cabin of a vehicle is applied to such vehicles equipped with batteries.

Incidentally, a refrigerant circuit system provided with a plurality of refrigerant circuits shares one compressor for the purpose of, for example, reducing the size and cost of the system and causes refrigerant flowing out from the compressor to flow into an evaporator in each of the refrigerant circuits to exchange heat (absorb heat).

In other words, refrigerant flowing out from the common compressor is supplied to the evaporator (chiller) of the first refrigerant circuit to cool the battery and is also supplied to the evaporator of the second refrigerant circuit to cool the vehicle cabin of the vehicle.

Various types of such a refrigerant circuit system provided with a plurality of refrigerant circuits and mounted on a vehicle have been suggested so far (see, for example, Japanese Patent No. 5643179 (JP 5643179 B) and Japanese Patent No. 5392298 (JP 5392298 B)).

### SUMMARY

As described above, for example, a refrigerant circuit system provided with a chiller that cools a battery and an evaporator that cools the vehicle cabin of a vehicle is applied to vehicles equipped with batteries. In such a refrigerant circuit system, for example, a first sensor that detects the temperature and pressure of refrigerant is provided at the outlet of the chiller of the first refrigerant circuit, and a second sensor that detects the temperature and pressure of refrigerant is provided at the outlet of the evaporator of the second refrigerant circuit.

A first expansion valve is provided at the inlet (upstream side) of the chiller, and the valve opening degree of the first expansion valve is electrically controlled based on an output of the first sensor. A second expansion valve is provided at the inlet of the evaporator, and the valve opening degree of the second expansion valve is electrically controlled based on an output of the second sensor. The compressor is controlled based on the priority assigned to each of the first refrigerant circuit and the second refrigerant circuit.

In other words, the refrigerant compression ratio of the compressor (the motor rotation speed of the electric compressor) is configured to be controlled based on a cooling request higher in priority between cooling of the battery by using the first refrigerant circuit and cooling of the vehicle cabin of the vehicle by using the second refrigerant circuit.

Therefore, when, for example, the motor rotation speed of the electric compressor is controlled based on a higher-priority request to the first refrigerant circuit to cool the battery, it is difficult to appropriately or efficiently cool the vehicle cabin of the vehicle by using the second refrigerant circuit, which is lower in priority.

In the specification, a refrigerant circuit system provided with a first refrigerant circuit that mainly cools a battery and a second refrigerant circuit that cools a vehicle cabin will be described as an example; however, a refrigerant circuit system to which the disclosure is applied is not limited to the one provided with two refrigerant circuits that respectively cool a battery and a vehicle cabin. In other words, the disclosure is widely applicable as a refrigerant circuit system provided with a plurality of refrigerant circuits that cool various portions and a control method therefor.

An embodiment that will be described in the specification provides a refrigerant circuit system and a control method therefor, which are capable of appropriately and efficiently controlling each of a plurality of refrigerant circuits.

A first aspect of the disclosure provides a refrigerant circuit system. The refrigerant circuit system includes a compressor configured to compress refrigerant, a condenser configured to cause the compressed refrigerant to radiate heat, first and second expansion valves each configured to decompress and expand the refrigerant from which heat has been radiated, by regulating a valve opening degree, a first evaporator configured to cause the refrigerant that has been decompressed and expanded by the first expansion valve, to absorb heat, a second evaporator provided in parallel with the first evaporator and configured to cause the refrigerant that has been decompressed and expanded by the second expansion valve, to absorb heat, and a controller.

The controller is configured to, based on first information related to a temperature of a first temperature regulated object, the temperature of the first temperature regulated object being regulated by the first evaporator, second information related to a temperature of a second temperature regulated object, the temperature of the second temperature regulated object being regulated by the second evaporator, and third information related to a degree of superheat of the refrigerant at an inlet of the compressor, control the valve opening degree of the first expansion valve, the valve opening degree of the second expansion valve, and a compression ratio of the refrigerant by the compressor.

In the refrigerant circuit system, the first expansion valve may be a first electric expansion valve configured such that the valve opening degree of the first expansion valve is electrically controlled, the second expansion valve may be a second electric expansion valve configured such that the valve opening degree of the second expansion valve is electrically controlled, the compressor may be an electric compressor configured such that the compression ratio of the refrigerant is controlled by a rotation speed of a motor, and the controller may be configured to control the valve opening degree of the first electric expansion valve, the valve opening degree of the second electric expansion valve, and the rotation speed of the motor of the electric compressor based on the first information, the second information, and the third information.

The refrigerant circuit system may further include a first sensor provided near the first evaporator and configured to detect the temperature of the first temperature regulated object, a second sensor provided near the second evaporator and configured to detect the temperature of the second temperature regulated object, and a third sensor provided at the inlet of the compressor and configured to detect a temperature and a pressure of the refrigerant at the inlet of the compressor at which first refrigerant flowing out from the first evaporator and second refrigerant flowing out from the second evaporator are mixed. The first information may include information on the temperature of the first temperature regulated object near the first evaporator, detected by the first sensor. The second information may include information on the temperature of the second temperature regulated object near the second evaporator, detected by the second sensor. The third information may include information on the temperature and the pressure of the refrigerant at the inlet of the compressor, detected by the third sensor.

In the refrigerant circuit system, the refrigerant circuit system may be applied to a vehicle equipped with a battery, the first evaporator may be a chiller configured to regulate a temperature of the battery, the first temperature regulated object may be coolant to be cooled by the chiller, the second evaporator may be an evaporator configured to regulate a temperature in a cabin of the vehicle, the second temperature regulated object may be cooling air to be cooled by the evaporator, the first information may include information on a flow rate of the coolant in the chiller, and the second information may include information on a flow rate of the cooling air in the evaporator.

In the refrigerant circuit system, the controller may be configured to increase the compression ratio of the refrigerant by compressor when at least one of the following conditions is satisfied:
(i) a temperature of the coolant in the chiller is lower than a first target value;
(ii) the flow rate of the coolant in the chiller is less than a second target value;
(iii) a temperature of the cooling air flowing through the evaporator is lower than a third target value;
(iv) the flow rate of the cooling air flowing through the evaporator is less than a fourth target value;
(v) a temperature of the refrigerant flowing through the condenser is higher than a fifth target value;
(vi) a flow rate of the refrigerant flowing through the condenser is less than a sixth target value; and
(vii) the degree of superheat of the refrigerant at the inlet of the compressor is lower than a seventh target value.

In the refrigerant circuit system, the controller may be configured to execute feedforward control over the valve opening degree of the first expansion valve, the valve opening degree of the second expansion valve, and the compression ratio of the refrigerant by the compressor based on a predetermined relational expression that uses the first information, the second information, and the third information as inputs.

In the refrigerant circuit system, the controller may be configured to execute feedforward control over the valve opening degree of the first expansion valve, the valve opening degree of the second expansion valve, and the compression ratio of the refrigerant by the compressor based on a prepared table that provides a relationship among the first information, the second information, and the third information.

In the refrigerant circuit system, the controller may be further configured to execute feedback control over the compression ratio of the refrigerant by the compressor based on the degree of superheat of the refrigerant at the inlet of the compressor.

In the refrigerant circuit system, the degree of superheat of the refrigerant may be a difference between a temperature of superheated vapor of the refrigerant and a saturation temperature at a pressure of the refrigerant.

A second aspect of the disclosure provides a control method for a refrigerant circuit system. The refrigerant circuit system includes a compressor configured to compress refrigerant, a condenser configured to cause the compressed refrigerant to radiate heat, first and second expansion valves each configured to decompress and expand the refrigerant from which heat has been radiated, by regulating a valve opening degree, a first evaporator configured to cause the refrigerant that has been decompressed and expanded by the first expansion valve, to absorb heat, and a second evaporator provided in parallel with the first evaporator and configured to cause the refrigerant that has been decompressed and expanded by the second expansion valve, to absorb heat. The control method includes, based on first information related to a temperature of a first temperature regulated object, the temperature of the first temperature regulated object being regulated by the first evaporator, second information related to a temperature of a second temperature regulated object, the temperature of the second temperature regulated object being regulated by the second evaporator, and third information related to a degree of superheat of the refrigerant at an inlet of the compressor, controlling the valve opening degree of the first expansion valve, the valve opening degree of the second expansion valve, and a compression ratio of the refrigerant by the compressor.

With the refrigerant circuit system and the control method therefor according to the first and second aspects, it is possible to appropriately and efficiently control each of a plurality of refrigerant circuits.

Objects and advantageous effects of the disclosure can be recognized and obtained by using elements and their combinations recited in the appended claims. Both the above general description and the below detailed description are illustrative and are not intended to limit the disclosure recited in the appended claims.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing an example of a refrigerant circuit;

FIG. 2 is a Mollier chart for illustrating the refrigerant circuit shown in FIG. 1;

FIG. 3 is a block diagram schematically showing an example of a refrigerant circuit system;

FIG. 4 is a block diagram schematically showing a refrigerant circuit system according to an embodiment;

FIG. 5 is a block diagram showing an example of an in-vehicle temperature regulating apparatus to which the refrigerant circuit system according to the embodiment is applied;

FIG. 6 is a view schematically showing an example of an air conditioning air duct of a vehicle equipped with the in-vehicle temperature regulating apparatus shown in FIG. 5;

FIG. 7 is a view schematically showing an example of the vehicle equipped with the in-vehicle temperature regulating apparatus shown in FIG. 5;

FIG. 8A and FIG. 8B are views for illustrating one example embodiment of a control method for the refrigerant circuit system according to the embodiment; and

FIG. 9 is a flowchart for illustrating an example of a process of controlling the refrigerant circuit system, shown in FIG. 8A and FIG. 8B.

### DETAILED DESCRIPTION OF EMBODIMENTS

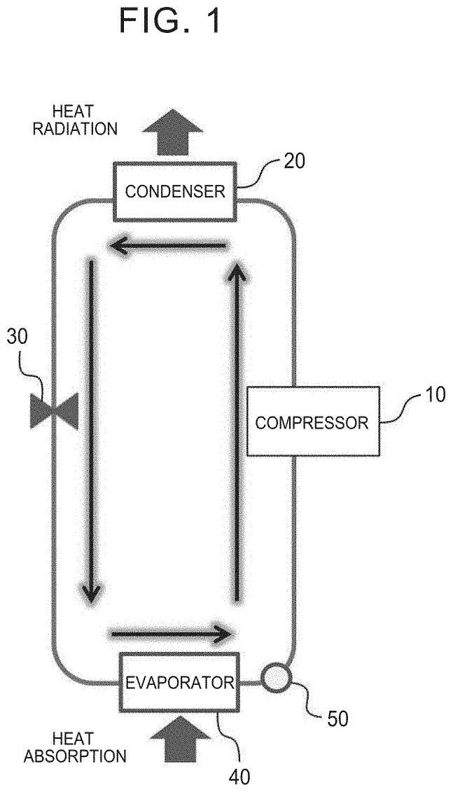

Initially, before a refrigerant circuit system and a control method therefor according to an embodiment is described in detail, an example of a refrigerant circuit system will be described with reference to FIG. 1 to FIG. 3.

FIG. 1 is a block diagram showing an example of a refrigerant circuit (refrigerating cycle). In FIG. 1, a compressor 10, a condenser 20, an expansion valve 30, an evaporator (evaporator or chiller) 40, and a temperature and pressure sensor (sensor) 50. The compressor 10 compresses refrigerant. The condenser 20 causes the refrigerant to radiate heat. The expansion valve 30 decompresses and expands refrigerant flowing into the evaporator 40. The evaporator 40 causes the refrigerant to absorb heat. Here, a temperature sensor and a pressure sensor of various known types may be applied as the temperature and pressure sensor 50.

The refrigerant circuit shown in FIG. 1 is, for example, mounted on a vehicle as an in-vehicle temperature regulating apparatus and switches by using a temperature regulating controller (not shown) between a heating mode in which heat radiation by the condenser 20 is used and a cooling mode in which heat absorption by the evaporator 40 is used. The temperature regulating controller is able to not only switch between the heating mode and the cooling mode in a vehicle cabin but also switch among, for example, a dehumidifying and heating mode, an internal cycle mode, and a dehumidifying and cooling mode, and is also able to adjust not only the temperature in the vehicle cabin but also the temperature of a battery or the like. In the specification, the refrigerant circuit system provided with a first refrigerant circuit that cools the battery and a second refrigerant circuit that cools the vehicle cabin will be mainly described as an example; however, the refrigerant circuit system is not limited to the one provided with the refrigerant circuit that cools the battery and the refrigerant circuit that cools the vehicle cabin. The refrigerant circuit system may include three or more refrigerant circuits.

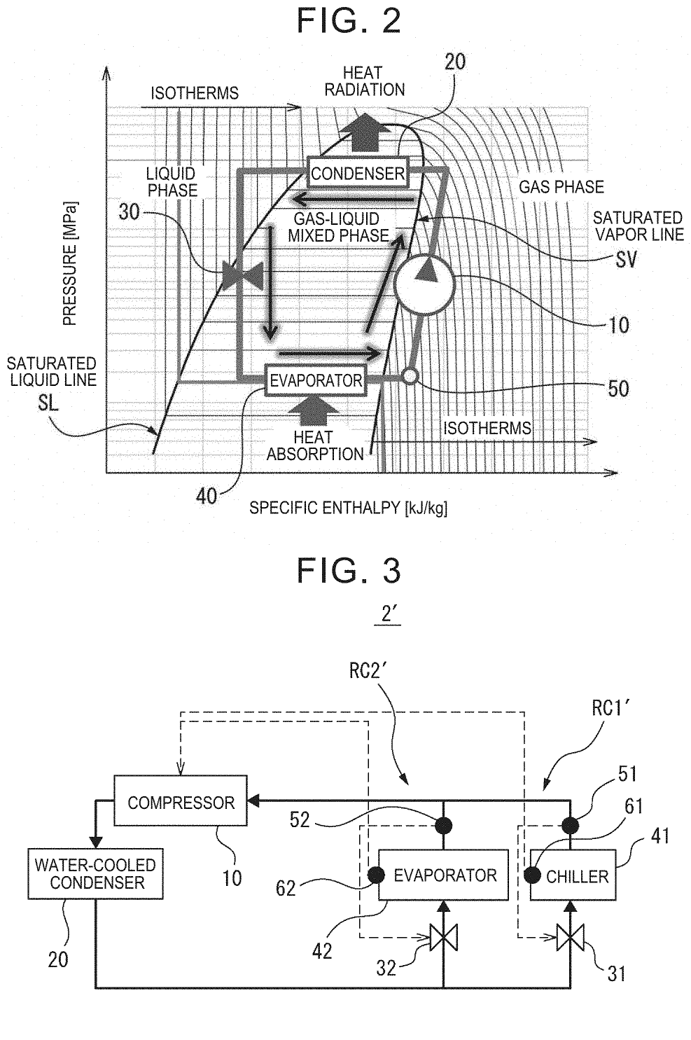

FIG. 2 is a Mollier chart (p-h chart) for illustrating the refrigerant circuit shown in FIG. 1. The ordinate axis represents pressure [MPa], and the abscissa axis represents specific enthalpy [kJ/kg]. As shown in FIG. 2, refrigerant is in a gas-liquid mixed phase (wet steam region) in a region inside a saturated liquid line SL and a saturated vapor line SV (the region surrounded by SL and SV), refrigerant is in a liquid phase (supercooled liquid region) in a region on the left-hand side (outside) of the saturated liquid line SL, and refrigerant is in a gas phase (superheated vapor region) in a region on the right-hand side (outside) of the saturated vapor line SV.

Here, the expansion valve 30 adjusts the pressure (evaporating pressure) of refrigerant flowing into the evaporator 40 by causing refrigerant liquid having passed through the condenser 20 to pass through, for example, a valve orifice that is a small hole for flowing fluid, to generate a pressure drop by the resistance of flow, and adjusts the flow rate of refrigerant in accordance with fluctuations in load on the evaporator 40. Thus, return of liquid to the compressor 10 is prevented by maintaining the degree of superheat of refrigerant at the outlet of the evaporator 40 at a constant degree.

The degree of superheat of refrigerant is the difference between the temperature of superheated vapor of refrigerant and a saturation temperature (saturated vapor line SV) at the pressure of the refrigerant and is used to indicate the degree of superheat of vapor. When the degree of superheat of refrigerant is insufficient, return of liquid (liquid compression) that refrigerant flows into the compressor 10 in a liquid or liquid droplet state (gas-liquid mixed phase state) occurs, and an excessively load is undesirably exerted on the compressor 10. When the degree of superheat of refrigerant is too high, waste occurs, with the result that the efficiency of the refrigerant circuit (in-vehicle temperature regulating apparatus) decreases.

FIG. 3 is a block diagram schematically showing an example of a refrigerant circuit system and showing a refrigerant circuit system 2′ provided with two refrigerant circuits RC1′, RC2′. The first refrigerant circuit RC1′ is made up of a compressor 10, a water-cooled condenser 20, an expansion valve (first expansion valve) 31, a chiller (first evaporator) 41, and a temperature and pressure sensor (first sensor) 51.

The second refrigerant circuit RC2′ is made up of the compressor 10, the water-cooled condenser 20, an expansion valve (second expansion valve) 32, an evaporator (second evaporator) 42, and a temperature and pressure sensor (second sensor) 52. In this way, in the refrigerant circuit system shown in FIG. 3, the compressor 10 and the water-cooled condenser 20 are shared between the two refrigerant circuits RC1′, RC2′.

FIG. 3 shows a temperature sensor 61 that detects the temperature of coolant cooled by the chiller 41 and also shows a temperature sensor 62 that detects the temperature of air cooled by the evaporator 42. The temperature sensor 61 outputs the detected temperature of coolant in the chiller 41 (temperature information or temperature signal) to the temperature regulating controller (electronic control unit (ECU)). The temperature sensor 62 outputs the detected temperature of cooling air in the evaporator 42 (temperature information or temperature signal) to the temperature regulating controller.

In the first refrigerant circuit RC1′, the valve opening degree of the first expansion valve 31 is subjected to feedback control based on the temperature and pressure of refrigerant (the degree of superheat of refrigerant), detected by the temperature and pressure sensor 51 provided at the outlet of the chiller 41. In the second refrigerant circuit RC2′, the valve opening degree of the second expansion valve 32 is subjected to feedback control based on the temperature and pressure of refrigerant, detected by the temperature and pressure sensor 52 provided at the outlet of the evaporator 42.

The compressor 10 is, for example, an electric compressor capable of controlling the compression ratio of refrigerant by the rotation speed of a motor. The compressor 10 is configured to give a higher priority to any one of a cooling request from a chiller (first refrigerant circuit RC1′) side that cools the battery and a cooling request from an evaporator (second refrigerant circuit RC2′) side that cools the vehicle cabin and execute feedback control over the rotation speed of the motor (the compression ratio of refrigerant) based on the cooling request given a higher priority.

In other words, in the refrigerant circuit system described with reference to FIG. 1 to FIG. 3, for example, the rotation speed of the motor of the compressor 10 is controlled based on a cooling request higher in priority between cooling of the battery by the first refrigerant circuit RC1′ and cooling of the vehicle cabin by the second refrigerant circuit RC2′. Therefore, it is difficult to appropriately and efficiently perform both cooling of the battery and cooling of the vehicle cabin.

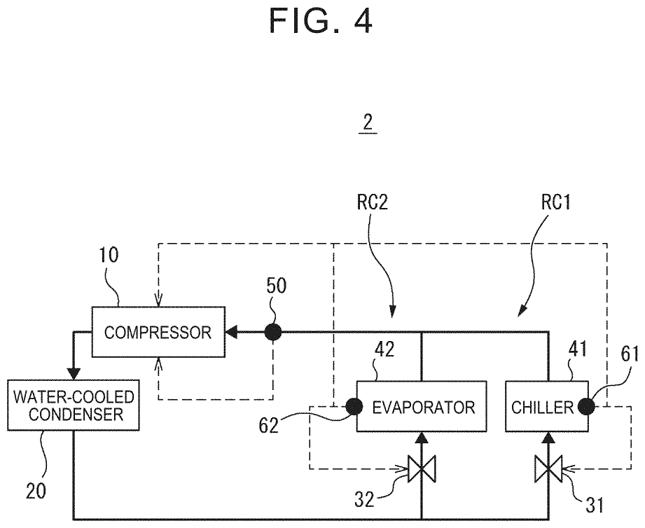

Hereinafter, the refrigerant circuit system and the control method therefor according to the present embodiment will be described in detail with reference to the accompanying drawings. FIG. 4 is a block diagram schematically showing a refrigerant circuit system according to the present embodiment and showing a refrigerant circuit system 2 provided with two refrigerant circuits RC1, RC2, which corresponds to the above-described refrigerant circuit system shown in FIG. 3.

As shown in FIG. 4, the first refrigerant circuit RC1 is made up of a compressor 10, a water-cooled condenser 20, an expansion valve (first expansion valve) 31, a chiller (first evaporator) 41, a temperature sensor (first sensor) 61, and a temperature and pressure sensor (third sensor) 50.

The second refrigerant circuit RC2 is made up of the compressor 10, the water-cooled condenser 20, an expansion valve (second expansion valve) 32, an evaporator (second evaporator) 42, a temperature sensor (second sensor) 62, and the temperature and pressure sensor 50. In this way, in the refrigerant circuit system 2 according to the present embodiment shown in FIG. 4, the compressor 10, the water-cooled condenser 20, and the temperature and pressure sensor 50 are shared between the two refrigerant circuits RC1, RC2.

In the first refrigerant circuit RC1, the temperature sensor 61 detects the temperature of coolant cooled by the chiller 41. In other words, the temperature sensor 61 detects the temperature of a first temperature regulated object (coolant) of which the temperature is regulated by the first evaporator (chiller 41) and outputs the detected temperature information (temperature signal or first information) on coolant in the chiller 41 to the temperature regulating controller (ECU). The temperature sensor 61 may detect, for example, the temperature around a coolant pipe through which coolant flows, without directly detecting the temperature of coolant of which the temperature is regulated by the chiller 41.

In the second refrigerant circuit RC2, the temperature sensor 62 detects the temperature of air cooled by the evaporator 42. In other words, the temperature sensor 62 detects the temperature of a second temperature regulated object (cooling air) of which the temperature is regulated by the second evaporator (evaporator 42) and outputs the detected temperature information (temperature signal or second information) on cooling air in the evaporator 42 to the temperature regulating controller. The temperature sensor 62 may detect the temperature at a predetermined location in the evaporator 42, which varies with the temperature of cooling air, without directly detecting the temperature of cooling air of which the temperature is regulated by the evaporator 42.

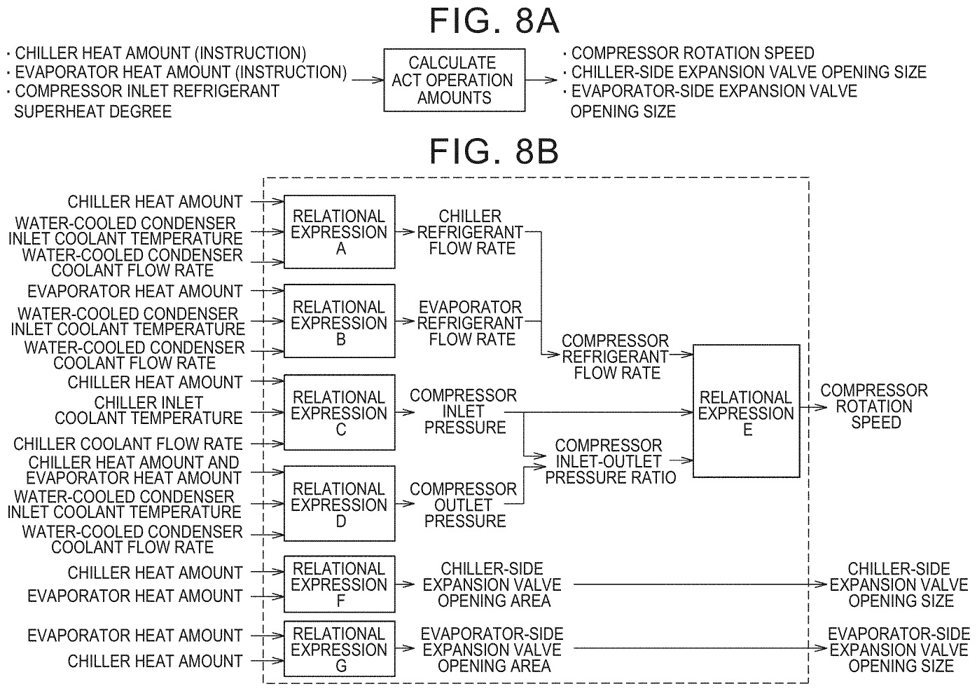

As will be described later in detail with reference to FIG. 8A and FIG. 8B, the first information to be input to the temperature regulating controller desirably includes not only temperature information on coolant flowing through the chiller 41 but also other information, such as the flow rate or the amount of heat of coolant, and the second information to be input to the temperature regulating controller also desirably includes not only temperature information on cooling air flowing through the evaporator 42 but also other information, such as the flow rate and the amount of heat of cooling air.

In the first refrigerant circuit RC1, the valve opening degree of the first expansion valve 31 is subjected to feedforward control based on the temperature of coolant in the chiller 41, detected by the temperature sensor 61. In the second refrigerant circuit RC2, the valve opening degree of the second expansion valve 32 is subjected to feedforward control based on the temperature of cooling air in the evaporator 42, detected by the temperature sensor 62.

Feedforward control over the valve opening degree of the first expansion valve 31 in the first refrigerant circuit RC1 is performed by using, for example, a predetermined relational expression based on the temperature of coolant in the chiller 41. Various known relational expressions may be applied as needed as a relational expression used in feedforward control over the valve opening degree of the first expansion valve 31. Alternatively, feedforward control over the valve opening degree of the first expansion valve 31, which is executed based on the temperature of coolant in the chiller 41, may be performed by creating a table that represents the relationship between the temperature of coolant in the chiller 41 and the valve opening degree of the first expansion valve 31 in advance and then using the table.

Similarly, feedforward control over the valve opening degree of the second expansion valve 32 in the second refrigerant circuit RC2 is performed by using, for example, a predetermined relational expression based on the temperature of cooling air in the evaporator 42. Various known relational expressions may be applied as needed as a relational expression used in feedforward control over the valve opening degree of the second expansion valve 32. Alternatively, feedforward control over the valve opening degree of the second expansion valve 32, which is executed based on the temperature of cooling air in the evaporator 42, may be performed by creating a table that represents the relationship between the temperature of cooling air in the evaporator 42 and the valve opening degree of the second expansion valve 32 in advance and then using the table.

In the above description, the compression ratio of refrigerant in the compressor 10 is controlled based on the output of the temperature and pressure sensor 50 provided at the inlet of the compressor 10. In other words, the rotation speed of the motor in the compressor 10 is subjected to feedback control by detecting the temperature and pressure of refrigerant (the degree of superheat of refrigerant) that is a mixture of refrigerant flowing out from the chiller 41 (first refrigerant) and refrigerant flowing out from the evaporator 42 (second refrigerant) with the temperature and pressure sensor 50 provided at the inlet of the compressor 10 and using the detected degree of superheat of refrigerant at the inlet of the compressor 10.

In this way, with the refrigerant circuit system 2 according to the present embodiment, it is possible to appropriately and efficiently cool the battery with the first refrigerant circuit RC1 and to appropriately and efficiently cool the vehicle cabin with the second refrigerant circuit RC2. In addition, with the refrigerant circuit system 2 according to the present embodiment, for example, the two temperature and pressure sensors 51, 52 in the refrigerant circuit system 2′ described with reference to FIG. 3 may be replaced with the single temperature and pressure sensor 50, and one of the temperature and pressure sensors is able to be reduced.

In the specification, a refrigerant circuit system provided with a first refrigerant circuit that mainly cools a battery and a second refrigerant circuit that cools a vehicle cabin will be described as an example; however, the refrigerant circuit system to which the disclosure is applied is not limited to the one provided with a first refrigerant circuit that cools the battery and a second refrigerant circuit that cools the vehicle cabin. In addition, a refrigerant circuit system to which the disclosure is applied may, of course, include three or more refrigerant circuits. Here, when the refrigerant circuit system includes a third refrigerant circuit that includes a third expansion valve and a third evaporator in addition to the first refrigerant circuit and the second refrigerant circuit, the valve opening degree of the third expansion valve is controlled based on, for example, temperature information detected by a temperature sensor provided in the third evaporator.

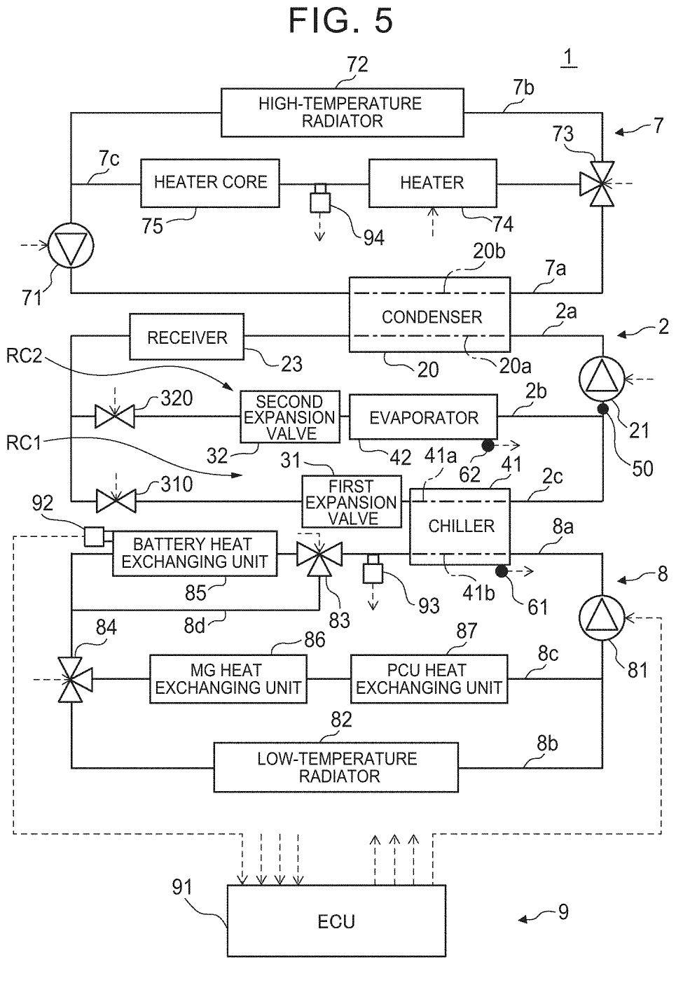

Next, an example of the in-vehicle temperature regulating apparatus to which the refrigerant circuit system according to the present embodiment is applied will be described in detail with reference to FIG. 5 to FIG. 7. FIG. 5 is a block diagram showing an example of an in-vehicle temperature regulating apparatus to which the refrigerant circuit system according to the embodiment is applied. FIG. 5 shows an in-vehicle temperature regulating apparatus 1, the refrigerant circuit system 2, a high-temperature circuit 7, a low-temperature circuit 8, and a controller (temperature regulating controller) 9.

As shown in FIG. 5, the in-vehicle temperature regulating apparatus 1 includes the refrigerant circuit system 2, the high-temperature circuit 7, the low-temperature circuit 8, and the controller 9. The refrigerant circuit system 2 includes a compressor (electric compressor) 21, a refrigerant pipe 20a of a condenser 20, a receiver 23, a first expansion valve 31, a second expansion valve 32, a refrigerant pipe 41a of a chiller 41, an evaporator 42, a first electromagnetic regulating valve 310, and a second electromagnetic regulating valve 320. The refrigerant circuit system 2 implements two refrigerant circuits by causing refrigerant to circulate through these components. A selected substance used as refrigerant in a general refrigerant circuit, for example, hydrofluorocarbon (for example, HFC-134a), is used as refrigerant.

The refrigerant circuit system 2 includes the two refrigerant circuits (RC1, RC2) described with reference to FIG. 4 and is divided into a basic refrigerant channel 2a, an evaporator channel 2b, and a chiller channel 2c. The evaporator channel 2b and the chiller channel 2c are provided in parallel with each other and both are connected to the basic refrigerant channel 2a. In other words, the first refrigerant circuit RC1 is made up of the basic refrigerant channel 2a and the chiller channel 2c, and the second refrigerant circuit RC2 is made up of the basic refrigerant channel 2a and the evaporator channel 2b.

The compressor 21, the refrigerant pipe 20a of the condenser 20, and the receiver 23 are provided in the basic refrigerant channel 2a in this order in a circulation direction of refrigerant. The first electromagnetic regulating valve 310, the first expansion valve 31, and the refrigerant pipe 41a of the chiller 41 are provided in the chiller channel 2c in this order in the circulation direction of refrigerant. The second electromagnetic regulating valve 320, the second expansion valve 32, and the evaporator 42 are provided in the evaporator channel 2b in this order in the circulation direction of refrigerant.

Refrigerant flows through the basic refrigerant channel 2a regardless of whether the first electromagnetic regulating valve 310 and the second electromagnetic regulating valve 320 are open or closed. When refrigerant flows through the basic refrigerant channel 2a, the refrigerant flows through the compressor 21, the refrigerant pipe 20a of the condenser 20, and the receiver 23 in this order. Refrigerant flows through the chiller channel 2c when the first electromagnetic regulating valve 310 is open. When refrigerant flows through the chiller channel 2c, the refrigerant flows through the first electromagnetic regulating valve 310, the first expansion valve 31, and the refrigerant pipe 41a of the chiller 41 in this order. Refrigerant flows through the evaporator channel 2b when the second electromagnetic regulating valve 320 is open. When refrigerant flows through the evaporator channel 2b, the refrigerant flows through the second electromagnetic regulating valve 320, the second expansion valve 32, and the evaporator 42 in this order.

The compressor 21 compresses refrigerant to increase the temperature of the refrigerant. The compressor 21 is configured as, for example, an electric compressor of which the compression ratio of refrigerant is controlled in accordance with the rotation speed of the motor. Here, the temperature and pressure sensor 50 is provided at the inlet of the compressor 21. In other words, low-temperature, low-pressure, mainly gas refrigerant flowing out from the chiller 41 (first refrigerant) and low-temperature, low-pressure, mainly gas refrigerant flowing out from the evaporator 42 (second refrigerant) are mixed, and the temperature and pressure of the mixed refrigerant (the degree of superheat of the mixed refrigerant) are detected by the temperature and pressure sensor 50 provided at the inlet of the compressor 21.

Signals (information) of the temperature and the pressure at the inlet of the compressor 20, detected by the temperature and pressure sensor 50, are output to an ECU 91 (temperature regulating controller 9). The temperature sensor (first sensor) 61 is provided in the chiller 41. The temperature sensor 61 detects the temperature of coolant cooled by the chiller 41 and outputs the detected temperature information on coolant to the ECU 91. The temperature sensor (second sensor) 62 is provided in the evaporator 42. The temperature sensor 62 detects the temperature of air cooled by the evaporator 42 and outputs the detected temperature information on cooling air in the evaporator 42 to the ECU 91.

The temperature sensor 61 is provided near a coolant pipe 41b in the chiller 41. The temperature sensor 61 detects the temperature around the coolant pipe 41b. For example, a first coolant temperature sensor 93 that detects the temperature of coolant flowing out from the coolant pipe 41b of the chiller 41 may be used as the temperature sensor 61. In other words, the temperature sensor 61 (first sensor) is provided around the chiller 41. The temperature sensor 61 detects a temperature related to coolant of which the temperature is regulated by the chiller 41 and outputs the temperature signal (temperature information) to the ECU 91. Similarly, the temperature sensor 62 (second sensor) is provided around the evaporator 42. The temperature sensor 62 detects a temperature related to cooling air of which the temperature is regulated by the evaporator 42 and outputs the temperature signal to the ECU 91.

The condenser 20 includes the refrigerant pipe 20a and a coolant pipe 20b. The condenser 20 exchanges heat between refrigerant flowing through the refrigerant pipe 20a and coolant flowing through the coolant pipe 20b and transfers heat from the refrigerant to the coolant. The refrigerant pipe 20a of the condenser 20 functions as a condenser that condenses refrigerant in the refrigerant circuit (refrigerating cycle). In the refrigerant pipe 20a of the condenser 20, high-temperature, high-pressure, mainly gas refrigerant flowing out from the compressor 21 is cooled isobarically to change into high-temperature, high-pressure, mainly liquid refrigerant.

The receiver 23 stores refrigerant condensed in the refrigerant pipe 20a of the condenser 20. In the condenser 20, not all the refrigerant is always liquefied, so the receiver 23 is configured to separate gas and liquid. Thus, only liquid refrigerant from which gas refrigerant is separated flows out from the receiver 23. The refrigerant circuit system 2 may use a subcooling condenser that incorporates a gas-liquid separator, as the condenser 20 instead of including the receiver 23.

Each of the first expansion valve 31 and the second expansion valve 32 includes a thin passage and sprays refrigerant from the thin passage to steeply decrease the pressure of refrigerant. In other words, the first expansion valve 31 sprays liquid refrigerant supplied from the receiver 23 into the refrigerant pipe 41a of the chiller 41 in a mist form. Similarly, the second expansion valve 32 sprays liquid refrigerant supplied from the receiver 23 into the evaporator 42 in a mist form. In each of the first and second expansion valves 31, 32, high-temperature, high-pressure liquid refrigerant flowing out from the receiver 23 is decompressed and partially vaporized to change into low-temperature, low-pressure misty refrigerant. Each of the first and second expansion valves 31, 32 is configured as an electric expansion valve of which the valve opening degree is electrically controllable.

The evaporator 42 functions as an evaporator that evaporates refrigerant. The evaporator 42 causes the refrigerant to absorb heat from air around the evaporator 42 and to evaporate. Therefore, in the evaporator 42, low-temperature, low-pressure misty refrigerant flowing out from the second expansion valve 32 evaporates to change into low-temperature, low-pressure gas refrigerant. As a result, air around the evaporator 42 is cooled, so the vehicle cabin is able to be cooled.

The chiller 41 includes the refrigerant pipe 41a and the coolant pipe 41b. The chiller 41 causes refrigerant to absorb heat from coolant in the low-temperature circuit 8 and to evaporate. In other words, the chiller 41 exchanges heat between coolant flowing through the coolant pipe 41b and refrigerant flowing through the refrigerant pipe 41a and transfers heat from the coolant to the refrigerant. Therefore, in the refrigerant pipe 41a of the chiller 41, low-temperature, low-pressure misty refrigerant flowing out from the first expansion valve 31 evaporates to change into low-temperature, low-pressure gas refrigerant. As a result, coolant in the low-temperature circuit 8 is cooled and is able to cool a battery (not shown) via a battery heat exchanging unit 85.

As described above, the valve opening degree of the first expansion valve 31, the valve opening degree of the second expansion valve 32, and the rotation speed of the motor in the compressor 21 are controlled by the ECU (controller) 91. A temperature signal of coolant, detected by the temperature sensor 61 provided in the chiller 41, a temperature signal of cooling air, detected by the temperature sensor 62 provided in the evaporator 42, and signals of the temperature and pressure of refrigerant, detected by the temperature and pressure sensor 50 provided at the inlet of the compressor 21 are input to the ECU 91. The temperature and pressure sensor 50 detects the temperature and pressure of refrigerant at the inlet of the compressor 21, at which refrigerant flowing out from the chiller 41 (first refrigerant) and refrigerant flowing out from the evaporator 42 (second refrigerant) are mixed, and outputs the detected temperature and pressure signals (information) to the ECU 91.

In other words, the valve opening degree of the first expansion valve 31 in the first refrigerant circuit RC1 is subjected to feedforward control based on the temperature (signal) of coolant, detected by the temperature sensor 61 provided in the chiller 41, and the valve opening degree of the second expansion valve 32 in the second refrigerant circuit RC2 is subjected to feedforward control based on the temperature (signal) of cooling air, detected by the temperature sensor 62 provided in the evaporator 42. Feedforward control over the valve opening degree of the first expansion valve 31 may be performed by using a predetermined relational expression based on the temperature of coolant in the chiller 41. Feedforward control over the valve opening degree of the second expansion valve 32 may be performed by using a predetermined relational expression based on the temperature of cooling air in the evaporator 42.

Alternatively, feedforward control over the valve opening degree of the first expansion valve 31 may be performed by using a prepared table that represents the relationship between the temperature of coolant in the chiller 41 and the valve opening degree of the first expansion valve 31, and feedforward control over the valve opening degree of the second expansion valve 32 may be performed by using a prepared table that represents the relationship between the temperature of cooling air in the evaporator 42 and the valve opening degree of the second expansion valve 32. The rotation speed of the motor in the compressor 21 is subjected to feedforward control based on the temperature and pressure of refrigerant (the degree of superheat of refrigerant), detected by the temperature and pressure sensor 50 provided at the inlet of the compressor 21.

The first electromagnetic regulating valve 310 and the second electromagnetic regulating valve 320 are used to control flow of refrigerant in the refrigerant circuit system 2. In other words, as the valve opening degree of the first electromagnetic regulating valve 310 increases, refrigerant flowing into the chiller channel 2c increases, with the result that refrigerant flowing into the chiller 41 increases. As the valve opening degree of the second electromagnetic regulating valve 320 increases, refrigerant flowing into the evaporator channel 2b increases, with the result that refrigerant flowing into the evaporator 42 increases. In the example shown in FIG. 5, each of the electromagnetic regulating valves 310, 320 is configured to be capable of regulating its valve opening degree. Alternatively, each of the electromagnetic regulating valves 310, 320 may be an open-close valve that is switched between an open state and a closed state. Instead of the first electromagnetic regulating valve 310 and the second electromagnetic regulating valve 320, a three-way valve capable of selectively causing refrigerant from the basic refrigerant channel 2a to flow into only the chiller channel 2c, only the evaporator channel 2b, or both may be provided. In other words, as long as the flow rate of refrigerant from the basic refrigerant channel 2a into the chiller channel 2c and the evaporator channel 2b is able to be regulated, various valves may be applied instead of the electromagnetic regulating valves 310, 320.

Next, the low-temperature circuit 8 will be described. The low-temperature circuit 8 includes a first pump 81, the coolant pipe 41b of the chiller 41, a low-temperature radiator 82, a first three-way valve 83, and a second three-way valve 84. The low-temperature circuit 8 further includes the battery heat exchanging unit 85, an MG heat exchanging unit 86, and a PCU heat exchanging unit 87. In the low-temperature circuit 8, coolant circulates through these components. Coolant is an example of a first heat medium, and, in the low-temperature circuit 8, a selected other heat medium may be used instead of coolant.

The low-temperature circuit 8 is divided into a basic low-temperature channel 8a, a low-temperature radiator channel 8b, and a high-temperature device channel 8c. The low-temperature radiator channel 8b and the high-temperature device channel 8c are provided in parallel with each other and both are connected to the basic low-temperature channel 8a.

The first pump 81, the coolant pipe 41b of the chiller 41, and the battery heat exchanging unit 85 are provided in the basic low-temperature channel 8a in this order in the circulation direction of coolant. A bypass channel 8d provided so as to bypass the battery heat exchanging unit 85 is connected to the basic low-temperature channel 8a. In the circulation direction of coolant, one end of the bypass channel 8d is connected between the chiller 41 and the battery heat exchanging unit 85, and the other end of the bypass channel 8d is connected to the downstream side of the battery heat exchanging unit 85. The first three-way valve 83 is provided at a portion at which the basic low-temperature channel 8a and the bypass channel 8d are connected.

The low-temperature radiator 82 is provided in the low-temperature radiator channel 8b. The MG heat exchanging unit 86 and the PCU heat exchanging unit 87 are provided in the high-temperature device channel 8c in this order in the circulation direction of coolant. A heat exchanging unit that exchanges heat with a high-temperature device other than a motor generator (MG) or a power control unit (PCU) may be provided in the high-temperature device channel 8c. The second three-way valve 84 is provided between the basic low-temperature channel 8a and both the low-temperature radiator channel 8b and the high-temperature device channel 8c.

The first pump 81 pressure-feeds coolant that circulates in the low-temperature circuit 8. The first pump 81 is configured as an electric water pump. The displacement of the first pump 81 is continuously varied by regulating electric power supplied.

The low-temperature radiator 82 is a heat exchanger that exchanges heat between coolant that circulates in the low-temperature circuit 8 and air outside a vehicle 100 (outside air). The low-temperature radiator 82 is configured to radiate heat from coolant to outside air when the temperature of coolant is higher than the temperature of outside air and absorb heat from outside air to coolant when the temperature of coolant is lower than the temperature of outside air.

The first three-way valve 83 is configured to selectively flow coolant, flowing out from the coolant pipe 41b of the chiller 41, to any one of the battery heat exchanging unit 85 and the bypass channel 8d. In the basic low-temperature channel 8a, when the first three-way valve 83 is set to the battery heat exchanging unit 85 side, coolant flows through the first pump 81, the coolant pipe 41b of the chiller 41, and the battery heat exchanging unit 85 in this order. On the other hand, when the first three-way valve 83 is set to the bypass channel 8d side, coolant does not flow through the battery heat exchanging unit 85, so coolant flows through only the first pump 81 and the chiller 41.

The second three-way valve 84 is configured to selectively flow refrigerant, flowing out from the basic low-temperature channel 8a, to any one of the low-temperature radiator channel 8b and the high-temperature device channel 8c. When the second three-way valve 84 is set to the low-temperature radiator channel 8b side, coolant flowing out from the basic low-temperature channel 8a flows through the low-temperature radiator 82. On the other hand, when the second three-way valve 84 is set to the high-temperature device channel 8c side, coolant flowing out from the basic low-temperature channel 8a flows through the MG heat exchanging unit 86 and the PCU heat exchanging unit 87 in this order. When the second three-way valve 84 is able to be set such that coolant flows through both, part of coolant flowing out from the basic low-temperature channel 8a flows through the low-temperature radiator 82, and the remaining part flows through the MG heat exchanging unit 86 and the PCU heat exchanging unit 87 in this order.

As long as the flow rate of coolant flowing into the battery heat exchanging unit 85 and the bypass channel 8d is able to be appropriately regulated, another regulating device, such as a regulating valve and an open-close valve, may be used instead of the first three-way valve 83. Similarly, as long as the flow rate of coolant flowing into the low-temperature radiator channel 8b and the high-temperature device channel 8c is able to be appropriately regulated, another regulating device, such as a regulating valve and an open-close valve, may be used instead of the second three-way valve 84.

The battery heat exchanging unit 85 is configured to exchange heat with the battery (not shown) of the vehicle 100. The battery heat exchanging unit 85 includes, for example, a pipe provided around the battery, and exchanges heat between the battery and coolant flowing through the pipe.

The MG heat exchanging unit 86 is configured to exchange heat with a motor generator (MG) (not shown) of the vehicle 100. Specifically, the MG heat exchanging unit 86 is configured to exchange heat between oil and coolant flowing around the MG. The PCU heat exchanging unit 87 is configured to exchange heat with a power control unit (PCU) (not shown) of the vehicle 100. Specifically, the PCU heat exchanging unit 87 includes a pipe provided around the PCU, and exchanges heat between the battery and coolant flowing through the pipe.

Next, the high-temperature circuit 7 will be described. The high-temperature circuit 7 includes a second pump 71, the coolant pipe 20b of the condenser 20, a high-temperature radiator 72, a third three-way valve 73, a heater 74, and a heater core 75. In the high-temperature circuit 7, coolant circulates through these components. Coolant is an example of a second heat medium, and, in the high-temperature circuit 7, a selected other heat medium may be used instead of coolant.

The high-temperature circuit 7 is divided into a basic high-temperature channel 7a, a high-temperature radiator channel 7b, and a heater channel 7c. The high-temperature radiator channel 7b and the heater channel 7c are provided in parallel with each other and both are connected to the basic high-temperature channel 7a.

The second pump 71 and the coolant pipe 20b of the condenser 20 are provided in the basic high-temperature channel 7a in this order in the circulation direction of coolant. The high-temperature radiator 72 is provided in the high-temperature radiator channel 7b. The heater (electric heater) 74 and the heater core 75 are provided in the heater channel 7c in this order in the circulation direction of coolant. The third three-way valve 73 is provided between the basic high-temperature channel 7a and both the high-temperature radiator channel 7b and the heater channel 7c.

The second pump 71 pressure-feeds coolant that circulates in the high-temperature circuit 7. The second pump 71 is configured as an electric water pump as in the case of the first pump 81. The high-temperature radiator 72, as well as the low-temperature radiator 82, is a heat exchanger that exchanges heat between outside air and coolant that circulates in the high-temperature circuit 7.

The third three-way valve 73 is configured to selectively flow coolant, flowing out from the coolant pipe 20b of the condenser 20, to any one of the high-temperature radiator channel 7b and the heater channel 7c. When the third three-way valve 73 is set to the high-temperature radiator channel 7b side, coolant flowing out from the coolant pipe 20b of the condenser 20 flows through the high-temperature radiator channel 7b. On the other hand, when the third three-way valve 73 is set to the heater channel 7c side, coolant flowing out from the coolant pipe 20b of the condenser 20 flows through the heater 74 and the heater core 75. As long as the flow rate of coolant flowing into the high-temperature radiator channel 7b and the heater channel 7c is able to be appropriately regulated, another regulating device, such as a regulating valve and an open-close valve, may be used instead of the third three-way valve 73.

The heater 74 functions as a heater that heats coolant. The heater 74 includes, for example, a heating resistor disposed around a pipe through which coolant flows. The heater 74 is configured to heat coolant in the pipe when electric power is supplied to the heating resistor. The heater 74 is, for example, used at the time of performing heating when the temperature of outside air is considerably low and, as a result, refrigerant does not appropriately function in the refrigerant circuit system 2.

The heater core 75 is configured to heat the vehicle cabin by exchanging heat between coolant that circulates in the high-temperature circuit 7 and air around the heater core 75. Specifically, the heater core 75 is configured to exhaust heat from coolant to air around the heater core 75. Therefore, when high-temperature coolant flows through the heater core 75, the temperature of the coolant decreases, and air around the heater core 75 is warmed.

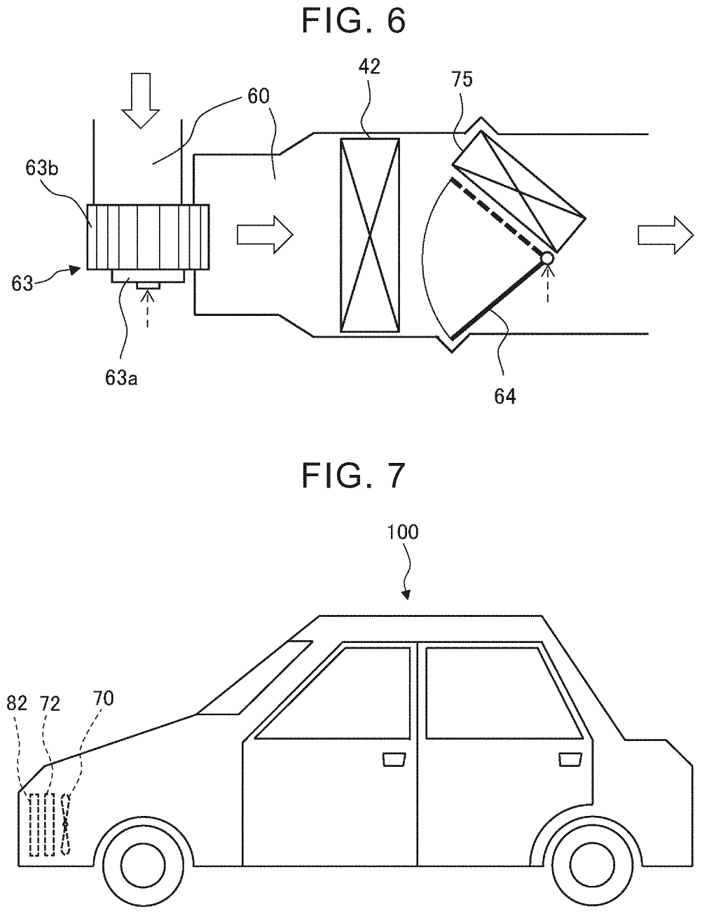

FIG. 6 is a view schematically showing an example of an air conditioning air duct of the vehicle equipped with the in-vehicle temperature regulating apparatus shown in FIG. 5. FIG. 7 is a view schematically showing an example of the vehicle equipped with the in-vehicle temperature regulating apparatus shown in FIG. 5.

As shown in FIG. 6, in an air conditioning air duct 60 of the vehicle 100 equipped with the in-vehicle temperature regulating apparatus 1, air flows in the direction indicated by the arrows in the drawing. The air duct 60 shown in FIG. 6 is connected to outside the vehicle 100 or an air inlet of the vehicle cabin, and outside air or air in the vehicle cabin flows into the air duct 60 in accordance with a status controlled by the controller 9. The air duct 60 shown in FIG. 6 is connected to outlets that blow air into the vehicle cabin, and air is supplied from the air duct 60 to a selected outlet in accordance with a status controlled by the controller 9.

A blower 63, the evaporator 42, an air mix door 64, and the heater core 75 are provided in the air conditioning air duct 60 shown in FIG. 6 in this order in the direction of flow of air.

The blower 63 includes a blower motor 63a and a blower fan 63b. The blower 63 is configured such that, when the blower fan 63b is driven by the blower motor 63a, outside air or air in the vehicle cabin flows into the air duct 60 and flows through the air duct 60.

The air mix door 64 regulates the flow rate of air flowing through the heater core 75 in air flowing through the air duct 60. The air mix door 64 is configured to be capable of regulating the air duct 60 among a state where all the air flowing through the air duct 60 flows through the heater core 75, a state where all the air flowing through the air duct 60 does not flow through the heater core 75, and an intermediate state.

In the thus configured air duct 60, when refrigerant is being circulated through the evaporator 42 while the blower 63 is being driven, air flowing through the air duct 60 is cooled. When coolant is being circulated through the heater core 75 and the air mix door 64 is controlled such that air flows through the heater core 75 while the blower 63 is being driven, air flowing through the air duct 60 is warmed.

FIG. 7 is a view schematically showing the vehicle 100 equipped with the in-vehicle temperature regulating apparatus 1. As shown in FIG. 7, the low-temperature radiator 82 and the high-temperature radiator 72 are disposed inside the front grille of the vehicle 100. Therefore, when the vehicle 100 is running, air hits the radiators 82, 72. A fan 70 is provided next to the radiators 82, 72. When the fan 70 is driven, air hits the radiators 82, 72. Therefore, even when the vehicle 100 is not running, the radiators 82, 72 are able to be hit by air when the fan 70 is driven.

As shown in FIG. 5, the controller 9 includes the electronic control unit (ECU) 91. The ECU 91 includes a processor that performs various operations, a memory that stores programs and various pieces of information, and an interface connected to various actuators and various sensors.

The controller 9 includes a battery temperature sensor 92 that detects the temperature of the battery, a first coolant temperature sensor 93 that detects the temperature of coolant flowing out from the coolant pipe 41b of the chiller 41, a second coolant temperature sensor 94 that detects the temperature of coolant flowing into the heater core 75. The ECU 91 is connected to these sensors, and output signals are input to the ECU 91 from these sensors.

The ECU 91 is connected to various actuators of the in-vehicle temperature regulating apparatus 1 and controls these actuators. Specifically, the ECU 91 is connected to the compressor 21, the electromagnetic regulating valves 310, 320, the pumps 81, 71, the three-way valves 83, 84, 73, the heater 74, the blower motor 63a, the air mix door 64, and the fan 70 and controls these components.

As described above, the ECU 91 is able to determine three actuator operation amounts, that is, the valve opening degree of the first expansion valve 31, the valve opening degree of the second expansion valve 32, and the compressor rotation speed (the motor rotation speed of the electric compressor 21) based on the temperature of the temperature regulated object (coolant) in the chiller 41, the temperature of the temperature regulated object (cooling air) in the evaporator 42, and the degree of superheat of refrigerant at the inlet of the compressor 21, and control the first expansion valve 31, the second expansion valve 32, and the compressor 21. This control may be performed by using a predetermined relational expression or table and is, for example, performed as follows.

Initially, when only the battery is further cooled to a temperature lower than at present (when the capacity of the chiller 41 for cooling coolant is increased), the ECU 91 executes control such that the compressor rotation speed is increased to a rotation speed higher than at present, the valve opening degree of the first expansion valve 31 is opened, and the valve opening degree of the second expansion valve 32 is closed. When only the air in the vehicle cabin is further cooled to a temperature lower than at present (when the capacity of the evaporator 42 for cooling the cooling air is increased), the ECU 91 executes control such that the compressor rotation speed is increased to a rotation speed higher than at present, the valve opening degree of the first expansion valve 31 is closed, and the valve opening degree of the second expansion valve 32 is opened. When the capacity of the chiller 41 for cooling coolant is decreased or when the capacity of the evaporator 42 for cooling the cooling air is decreased, the ECU 91 executes control conversely.

When both the battery and the vehicle cabin are further cooled, the ECU 91 executes control such that the compressor rotation speed is increased to a rotation speed higher than at present and both the valve opening degree of the first expansion valve 31 and the valve opening degree of the second expansion valve 32 are opened. When only the degree of superheat of refrigerant at the inlet of the compressor 21 is further increased to a degree higher than at present, the ECU 91 executes control such that the compressor rotation speed is increased and both the valve opening degree of the first expansion valve 31 and the valve opening degree of the second expansion valve 32 are closed.

In this way, with the refrigerant circuit system 2 according to the present embodiment, for example, three controlled objects, that is, the valve opening degree of the first expansion valve 31, the valve opening degree of the second expansion valve 32, and the compressor rotation speed, are controlled for a set of three parameters (a set of parameters in the same number as the number of the controlled objects), that is, the temperature of coolant in the chiller 41, the temperature of cooling air in the evaporator 42, and the degree of superheat of refrigerant at the inlet of the compressor 21, so requests based on the respective parameters are satisfied. With the refrigerant circuit system 2 according to the present embodiment, for example, it is possible to appropriately and efficiently cool the battery with the first refrigerant circuit RC1 and to appropriately and efficiently cool the vehicle cabin with the second refrigerant circuit RC2. In addition, with the refrigerant circuit system 2 according to the present embodiment, for example, the two temperature and pressure sensors 51, 52 in the refrigerant circuit system 2′ described with reference to FIG. 3 may be replaced with the single temperature and pressure sensor 50, and one of the temperature and pressure sensors is able to be reduced. The in-vehicle temperature regulating apparatus described with reference to FIG. 5 to FIG. 7 is merely an example in which the refrigerant circuit system 2 according to the present embodiment is applied, and the refrigerant circuit system 2 according to the present embodiment is not limited to application to the in-vehicle temperature regulating apparatus of FIG. 5 to FIG. 7.

In the above-description, information (signals) to be given to the ECU 91 is not limited to temperature information on coolant, detected by the temperature sensor 61 provided near the chiller 41, temperature information on cooling air, detected by the temperature sensor 62 provided near the evaporator 42, and information on the temperature and pressure of refrigerant, detected by the temperature and pressure sensor 50 provided at the inlet of the compressor 21.

FIG. 8A and FIG. 8B are views for illustrating one example embodiment of a control method for the refrigerant circuit system according to the present embodiment and are views for illustrating a process of calculating actuator operation amounts. FIG. 8A schematically shows a process of calculating actuator (ACT) operation amounts in the control method for the refrigerant circuit system. FIG. 8B shows an example of the process of calculating ACT operation amounts, shown in FIG. 8A, in more details.

As shown in FIG. 8A, the process of calculating ACT operation amounts in the refrigerant circuit system 2 according to the present embodiment, for example, uses a chiller heat amount, an evaporator heat amount, and a compressor inlet refrigerant superheat degree as inputs and is executed by the ECU 91 (temperature regulating controller 9) to control the compressor rotation speed (the motor rotation speed of the electric compressor 21), the chiller-side expansion valve opening size (the valve opening degree of the first expansion valve 31), and the evaporator-side expansion valve opening size (the valve opening degree of the second expansion valve 32).

The chiller heat amount is the amount of heat transfer per unit time (amount of heat: [kW]) needed to follow a target temperature of the temperature regulated object in the chiller 41. The evaporator heat amount is the amount of heat transfer per unit time (amount of heat: [kW]) needed to follow a target temperature of the temperature regulated object in the evaporator 42. A compressor inlet refrigerant superheat degree is the degree of superheat of refrigerant at the inlet of the compressor 21 at which first refrigerant having exchanged heat in the chiller 41 and second refrigerant having exchanged heat in the evaporator 42 are mixed. The degree of superheat of refrigerant at the inlet of the compressor 21 is able to be obtained from a detection signal of the temperature and pressure sensor 50 provided at the inlet of the compressor 21.

In other words, as shown in FIG. 8B, a chiller refrigerant flow rate (the flow rate of refrigerant flowing through the refrigerant pipe 41a of the chiller 41) is able to be calculated by a relational expression A that uses the chiller heat amount, a water-cooled condenser inlet coolant temperature (the temperature of coolant flowing through the coolant pipe 20b at the inlet of the coolant pipe 20b of the water-cooled condenser 20), and a water-cooled condenser coolant flow rate (the flow rate of coolant flowing through the coolant pipe 20b of the water-cooled condenser 20) as inputs. When the condenser 20 is not a water-cooled condenser and is an air-cooled condenser, it is possible to obtain an air-cooled condenser inlet coolant temperature from the temperature of outside air, the travel speed of the vehicle, and the like. An evaporator refrigerant flow rate (the flow rate of refrigerant flowing through the evaporator 42) is able to be calculated by a relational expression B that uses the evaporator heat amount, the water-cooled condenser inlet coolant temperature, and the water-cooled condenser coolant flow rate. A compressor refrigerant flow rate (the flow rate of refrigerant flowing through the compressor 21) is able to be obtained from the chiller refrigerant flow rate and the evaporator refrigerant flow rate.

A compressor inlet pressure (the pressure of refrigerant at the inlet of the compressor 21) is able to be calculated by a relational expression C that uses the chiller heat amount, a chiller inlet coolant temperature (the temperature of coolant at the inlet of the coolant pipe 41b of the chiller 41), and a chiller coolant flow rate (the flow rate of coolant flowing through the coolant pipe 41b of the chiller 41) as inputs. A compressor outlet pressure (the pressure of refrigerant at the outlet of the compressor 21) is able to be calculated by a relational expression D that uses the chiller heat amount and the evaporator heat amount, the water-cooled condenser inlet coolant temperature, and the water-cooled condenser coolant flow rate as inputs. A compressor inlet-outlet pressure ratio (the pressure ratio of refrigerant between the inlet and outlet of the compressor 21) is able to be obtained from the compressor inlet pressure and the compressor outlet pressure. The compressor rotation speed is able to be calculated by a relational expression E that uses the compressor refrigerant flow rate, the compressor inlet pressure, and the compressor inlet-outlet pressure ratio as inputs.

The chiller-side expansion valve opening size is able to be obtained from a chiller-side expansion valve opening area, and the chiller-side expansion valve opening area is able to be calculated by a relational expression F that uses the chiller heat amount and the evaporator heat amount as inputs. In other words, the valve opening degree of the first expansion valve 31 in the first refrigerant circuit RC1 is able to be obtained by inputting the chiller heat amount and the evaporator heat amount to the relational expression F. Similarly, the evaporator-side expansion valve opening size is able to be obtained from an evaporator-side expansion valve opening area, and the evaporator-side expansion valve opening area is able to be calculated by a relational expression G that uses the evaporator heat amount and the chiller heat amount as inputs. In other words, the valve opening degree of the second expansion valve 32 in the second refrigerant circuit RC2 is able to be obtained by inputting the evaporator heat amount and the chiller heat amount to the relational expression G.

As described above, in one example embodiment of the control method for the refrigerant circuit system, shown in FIG. 8A and FIG. 8B, the amount of heat transfer per unit time (amount of heat: [kW]) of the chiller 41, needed to follow the target temperature of the temperature regulated object (coolant) in the chiller 41 and the amount of heat of the evaporator 42, needed to follow the target temperature of the temperature regulated object (cooling air) in the evaporator 42, are calculated. In addition, the operation amounts, that is, the valve opening degree of the first expansion valve, the valve opening degree of the second expansion valve, and the compressor rotation speed, are obtained from information on the current states of objects with which the refrigerant circuit system 2 exchanges heat, that is, in addition to the amount of heat of coolant in the chiller 41 and the amount of heat of cooling air in the evaporator 42, the degree of superheat of refrigerant at the inlet of the compressor 21, the temperature and flow rate of coolant in the chiller 41, the temperature and flow rate of cooling air in the evaporator 42, and the temperature and flow rate of coolant in the water-cooled condenser 20, and feedforward control is executed by using these operation amounts as instruction values.

In other words, it is possible to execute highly responsive control by executing feedforward control over the valve opening degree of the first expansion valve 31, the valve opening degree of the second expansion valve 32, and the motor rotation speed of the compressor 21. The feedforward control is able to be executed based on the above-described predetermined relational expressions A, B, C, D, E, F, and G. Alternatively, the feedforward control may be executed by using a prepared table that associates output values with input data and that corresponds to the relational expressions A, B, C, D, E, F, and G. Such a process is, for example, as follows.

Initially, when a chiller coolant temperature (the temperature of coolant flowing through the chiller 41) is lower than a target value or when the chiller coolant flow rate (the flow rate of coolant flowing through the chiller 41) is less than a target value, the compressor rotation speed is increased. When an evaporator air temperature (the temperature of cooling air flowing through the evaporator 42) is lower than a target value or when an evaporator air volume (the flow rate of cooling air flowing through the evaporator 42) is less than a target value, the compressor rotation speed is increased. When a water-cooled condenser coolant temperature (the temperature of coolant flowing through the water-cooled condenser 20) is higher than a target value or when a water-cooled condenser coolant flow rate (the flow rate of coolant flowing through the water-cooled condenser 20) is less than a target value, the compressor rotation speed is increased.

The compressor rotation speed (the motor rotation speed of the electric compressor 21) is preferably subjected to feedback control based on temperature and pressure information at the inlet of the compressor 21 (compressor inlet refrigerant superheat degree), detected by the temperature and pressure sensor 50 provided at the inlet of the compressor 21, such that a deviation reduces with respect to the target value of the compressor inlet refrigerant superheat degree (the degree of superheat of refrigerant at the inlet of the compressor 21). Here, executing feedback control over only the compressor rotation speed based on the compressor inlet refrigerant superheat degree is to reliably prevent breakage of the compressor 21 due to liquid-phase refrigerant flowing into the compressor 21.

In other words, this is because, when regulation is performed such that a deviation reduces with respect to the target value of the compressor inlet refrigerant superheat degree, it is possible to reduce influence on deviations with respect to the target values of the temperatures, amounts of heat, and the like of the temperature regulated objects (coolant flowing through the chiller 41 and cooling air flowing through the evaporator 42). In addition, this is because, when the compressor rotation speed is not regulated and the valve opening degree of one of the first expansion valve 31 and the second expansion valve 32 is regulated, the distribution between refrigerant flowing through the first refrigerant circuit RC1 and refrigerant flowing through the second refrigerant circuit RC2 varies and, as a result, deviations increase with respect to the target values of the temperatures, amounts of heat, and the like of the temperature regulated objects. In other words, when the compressor inlet refrigerant superheat degree is lower than the target value, the compressor rotation speed is increased.

In the above description, various known relational expressions may be applied to the relational expressions A, B, C, D, E, F, and G as needed. The motor rotation speed of the electric compressor 21 (compressor rotation speed), the valve opening degree of the first expansion valve 31 in the first refrigerant circuit RC1 (chiller-side expansion valve opening area), and the valve opening degree of the second expansion valve 32 in the second refrigerant circuit RC2 (evaporator-side expansion valve opening area) are able to be calculated and subjected to feedforward control by inputting the above-described various pieces of information (data) to the relational expressions A, B, C, D, E, F, and G. Instead of using the relational expressions A, B, C, D, E, F, and G, feedforward control may be executed by using a prepared table that associates output values with input data and that corresponds to the relational expressions A, B, C, D, E, F, and G.

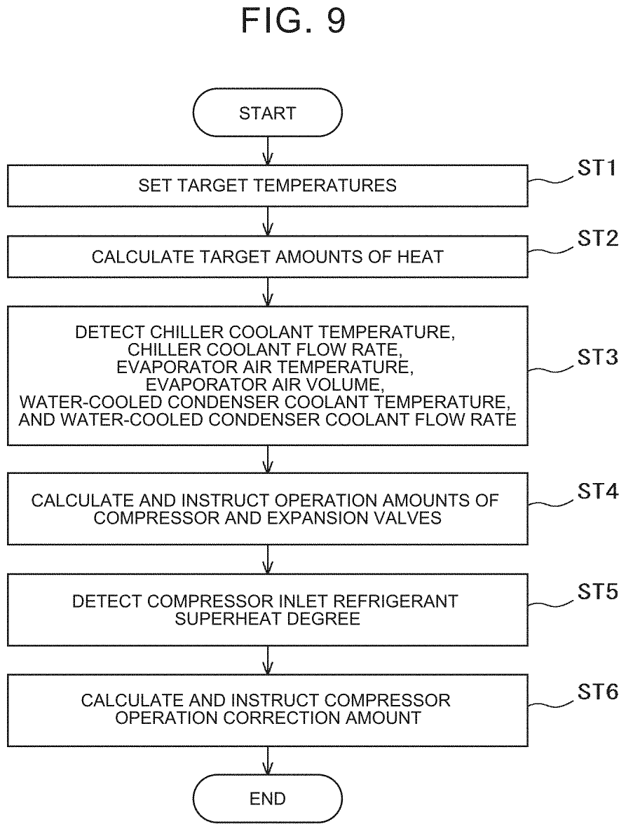

FIG. 9 is a flowchart for illustrating an example of a control process for the refrigerant circuit system, shown in FIG. 8A and FIG. 8B. As shown in FIG. 9, when an example of the control process (control method) for the refrigerant circuit system is started, a target temperature is set in step ST1, the process proceeds to step ST2, and a target amount of heat is calculated.

In other words, in step ST1, based on an instruction from the ECU 91, the target temperature of coolant to be cooled (regulated in temperature) by the chiller 41 and the target temperature of cooling air to be cooled by the evaporator 42 are set. The target amount of heat of coolant and the target amount of heat of cooling air, to be calculated in step ST2, are calculated based on, for example, the target temperature of coolant and the target temperature of cooling air, set in step ST1, and the like.

Subsequently, the process proceeds to step ST3, and a chiller coolant temperature, a chiller coolant flow rate, an evaporator air temperature, an evaporator air volume, a water-cooled condenser coolant temperature, and a water-cooled condenser coolant flow rate are detected. In other words, in step ST3, the temperature and flow rate of coolant flowing through the coolant pipe 41b of the chiller 41, the temperature and flow rate of cooling air flowing through the evaporator 42 (air conditioning air duct 60), and the temperature and flow rate of coolant flowing through the coolant pipe 20b of the water-cooled condenser 20 are deleted.

The temperature and flow rate of coolant flowing through the coolant pipe 41b, the temperature and flow rate of cooling air flowing through the air conditioning air duct 60, and the temperature and flow rate of coolant flowing through the coolant pipe 20b, to be detected in step ST3, are respectively detected by appropriate sensors, and information (signals) on the temperatures and flow rates detected by the sensors are input to the ECU 91. It is assumed that heat is sufficiently exchanged in the chiller 41, the evaporator 42, the water-cooled condenser 20, and the like, and, for example, the temperature of coolant to be cooled by the chiller 41 and the temperature of cooling air to be cooled by the evaporator 42 are deleted, and the detected temperature information on coolant and cooling air may be output to the ECU 91.

In other words, for example, the temperature sensor (first sensor) 61 is provided near the chiller (first evaporator) 41, and the temperature of coolant (first temperature regulated object) flowing through the coolant pipe 41b to be cooled by the chiller 41 is detected by the temperature sensor 61. Similarly, for example, the temperature sensor (second sensor) 62 is provided near the evaporator (second evaporator) 42, and the temperature sensor 62 detects the temperature of cooling air (second temperature regulated object) to be cooled by the evaporator 42 and flowing through the air conditioning air duct 60. Temperature information (signal) on coolant, detected by the temperature sensor 61, and temperature information on cooling air, detected by the temperature sensor 62 are output to the ECU 91.

Then, the process proceeds to step ST4, and the operation amounts of the compressor and the expansion valves are calculated and instructed. In other words, in step ST4, the ECU 91 controls the motor rotation speed of the electric compressor 21, the valve opening degree of the first expansion valve 31, and the valve opening degree of the second expansion valve 32 based on the input various pieces of information (signals). Specifically, in the first refrigerant circuit RC1, the valve opening degree of the first expansion valve 31 is able to be controlled based on the temperature signal of coolant, detected by the temperature sensor 61 provided near the chiller 41. Similarly, in the second refrigerant circuit RC2, the valve opening degree of the second expansion valve 32 is able to be controlled based on the temperature signal of cooling air, detected by the temperature sensor 62 provided near the evaporator 42.

In step ST5, the degree of superheat of refrigerant at the inlet of the compressor 21 is detected, the process proceeds to step ST6, and an operation correction amount of the compressor 21 is calculated and instructed (controlled). In other words, in step ST5, the temperature and pressure of refrigerant at the inlet of the compressor 21, at which first refrigerant after heat has been exchanged (heat has been absorbed) in the chiller 41 and second refrigerant at which heat has been exchanged (heat has been absorbed) in the evaporator 42 are mixed, are detected by the temperature and pressure sensor 50 provided at the inlet of the compressor 21, and information (signals) on the temperature and the pressure is output to the ECU 91.

In step ST6, feedback control is executed. In feedback control, the degree of superheat of refrigerant at the inlet of the compressor 21 is calculated from the information on the temperature and pressure of refrigerant, detected by the temperature and pressure sensor 50 provided at the inlet of the compressor 21, and the compressor rotation speed (the motor rotation speed of the electric compressor 21) is controlled such that the calculated degree of superheat of refrigerant becomes an intended degree of superheat of refrigerant. The above-described control process (control method) for the refrigerant circuit system is, of course, able to be executed as, for example, a program that is run by the ECU 91 shown in FIG. 5.

The above-described example embodiment of the refrigerant circuit system and control method therefor illustrates only a mere example and, of course, various modifications, changes, and the like are possible. The refrigerant circuit system and the control method therefor according to the present embodiment are not limited to a refrigerant circuit mounted on a vehicle and may be widely applied to various refrigerant circuits that include an electric compressor and electric expansion valves.

The embodiment has been described above. All examples and conditions described here are intended to help understand the disclosure and the concept of the disclosure applied to technologies, and specific examples and conditions are not intended to limit the scope of the disclosure. Such a description in the specification does not point out the advantages or disadvantages of the disclosure. The embodiment of the disclosure has been described in detail, and it should be understood that various changes, replacements, and modifications are possible without departing from the spirt or scope of the disclosure.

What is claimed is:

1. A refrigerant circuit system comprising:
a compressor configured to compress refrigerant;
a condenser configured to cause the compressed refrigerant to radiate heat;
first and second expansion valves each configured to decompress and expand the refrigerant from which heat has been radiated, by regulating a valve opening degree;
a first evaporator configured to cause the refrigerant that has been decompressed and expanded by the first expansion valve, to absorb heat;
a second evaporator provided in parallel with the first evaporator and configured to cause the refrigerant that has been decompressed and expanded by the second expansion valve, to absorb heat; and
a controller configured to, based on first information related to a temperature of a first temperature regulated object, the temperature of the first temperature regulated object being regulated by the first evaporator, second information related to a temperature of a second temperature regulated object, the temperature of the second temperature regulated object being regulated by the second evaporator, and third information related to a degree of superheat of the refrigerant at an inlet of the compressor, control the valve opening degree of the first expansion valve, the valve opening degree of the second expansion valve, and a compression ratio of the refrigerant by the compressor.

2. The refrigerant circuit system according to claim 1, wherein:
the first expansion valve is a first electric expansion valve configured such that the valve opening degree of the first expansion valve is electrically controlled;
the second expansion valve is a second electric expansion valve configured such that the valve opening degree of the second expansion valve is electrically controlled;
the compressor is an electric compressor configured such that the compression ratio of the refrigerant is controlled by a rotation speed of a motor; and
the controller is configured to control the valve opening degree of the first electric expansion valve, the valve opening degree of the second electric expansion valve, and the rotation speed of the motor of the electric compressor based on the first information, the second information, and the third information.

3. The refrigerant circuit system according to claim 1, further comprising:
a first sensor provided near the first evaporator and configured to detect the temperature of the first temperature regulated object;
a second sensor provided near the second evaporator and configured to detect the temperature of the second temperature regulated object; and
a third sensor provided at the inlet of the compressor and configured to detect a temperature and a pressure of the refrigerant at the inlet of the compressor at which first refrigerant flowing out from the first evaporator and second refrigerant flowing out from the second evaporator are mixed, wherein:
the first information includes information on the temperature of the first temperature regulated object near the first evaporator, detected by the first sensor;
the second information includes information on the temperature of the second temperature regulated object near the second evaporator, detected by the second sensor; and
the third information includes information on the temperature and the pressure of the refrigerant at the inlet of the compressor, detected by the third sensor.

4. The refrigerant circuit system according to claim 1, wherein:
the refrigerant circuit system is applied to a vehicle equipped with a battery;
the first evaporator is a chiller configured to regulate a temperature of the battery;
the first temperature regulated object is coolant to be cooled by the chiller;
the second evaporator is an evaporator configured to regulate a temperature in a cabin of the vehicle;
the second temperature regulated object is cooling air to be cooled by the evaporator;
the first information includes information on a flow rate of the coolant in the chiller; and
the second information includes information on a flow rate of the cooling air in the evaporator.

5. The refrigerant circuit system according to claim 4, wherein the controller is configured to increase the compression ratio of the refrigerant by the compressor when at least one of following conditions is satisfied:
(i) a temperature of the coolant in the chiller is lower than a first target value;
(ii) the flow rate of the coolant in the chiller is less than a second target value;
(iii) a temperature of the cooling air flowing through the evaporator is lower than a third target value;
(iv) the flow rate of the cooling air flowing through the evaporator is less than a fourth target value;
(v) a temperature of the refrigerant flowing through the condenser is higher than a fifth target value;
(vi) a flow rate of the refrigerant flowing through the condenser is less than a sixth target value; and
(vii) the degree of superheat of the refrigerant at the inlet of the compressor is lower than a seventh target value.

6. The refrigerant circuit system according to claim 1, wherein the controller is configured to execute feedforward control over the valve opening degree of the first expansion valve, the valve opening degree of the second expansion valve, and the compression ratio of the refrigerant by the compressor based on a predetermined relational expression that uses the first information, the second information, and the third information as inputs.

7. The refrigerant circuit system according to claim 1, wherein the controller is configured to execute feedforward control over the valve opening degree of the first expansion valve, the valve opening degree of the second expansion valve, and the compression ratio of the refrigerant by the compressor based on a prepared table that provides a relationship among the first information, the second information, and the third information.

8. The refrigerant circuit system according to claim 6, wherein the controller is further configured to execute feedback control over the compression ratio of the refrigerant by the compressor based on the degree of superheat of the refrigerant at the inlet of the compressor.

9. The refrigerant circuit system according to claim 5, wherein the degree of superheat of the refrigerant is a difference between a temperature of superheated vapor of the refrigerant and a saturation temperature at a pressure of the refrigerant.

10. A control method for a refrigerant circuit system that includes a compressor configured to compress refrigerant, a condenser configured to cause the compressed refrigerant to radiate heat, first and second expansion valves each configured to decompress and expand the refrigerant from which heat has been radiated, by regulating a valve opening degree, a first evaporator configured to cause the refrigerant that has been decompressed and expanded by the first expansion valve, to absorb heat, and a second evaporator provided in parallel with the first evaporator and configured to cause the refrigerant that has been decompressed and expanded by the second expansion valve, to absorb heat, the control method comprising
based on first information related to a temperature of a first temperature regulated object, the temperature of the first temperature regulated object being regulated by the first evaporator, second information related to a temperature of a second temperature regulated object, the temperature of the second temperature regulated object being regulated by the second evaporator, and third information related to a degree of superheat of the refrigerant at an inlet of the compressor, controlling the valve opening degree of the first expansion valve, the valve opening degree of the second expansion valve, and a compression ratio of the refrigerant by the compressor.
